(19) United States
(12) Patent Application Publication
(10) Pub. No.: US 2007/0246071 A1
(43) Pub. Date: Oct. 25, 2007

(54) Method for transporting items to be cleaned through a conveyor-type dishwasher, and a conveyor-type dishwasher

(76) Inventor: Michael Streb, Iffezheim (DE)

Correspondence Address: MCGRATH, GEISSLER, OLDS & RICHARDSON, PLLC, P.O. BOX 1364, FAIRFAX, VA, 22038-1364, US

(21) Appl. No.: 11/783,417

(22) Filed: Apr. 9, 2007

Related U.S. Application Data
(63) Continuation of application No. PCT/EP05/10468, filed on Sep. 28, 2005.

(30) Foreign Application Priority Data
Oct. 8, 2004 (DE) 10 2004 049 392.8

(51) Int. Cl. B08B 3/00

(52) U.S. Cl. 134/18; 134/56 D; 134/61

(57) ABSTRACT

A method for transporting items to be cleaned through a conveyor-type dishwasher and a conveyor-type dishwasher is provided. The conveyor-type dishwasher comprises a wash zone, a final-rinse zone and a drying zone. The items to be cleaned are cleaned in the wash zone, rinsed clear in the final-rinse zone and dried in the drying zone. Transportation devices are provided, which are used to transport the items being cleaned in the conveyor direction at a transportation speed which is optimum for the process steps being executed in the respective zones.

This nonprovisional application is a continuation of International Application No.: PCT/EP2005/010468, which was filed on Sep. 28, 2005, and which claims priority to German Patent Application No. DE 102004049392, which was filed in Germany on Oct. 8, 2004, and which are both herein incorporated by reference.

### BACKGROUND OF THE INVENTION

1. Field of the Invention

The present invention relates to a method for transporting items to be cleaned through a conveyor-type dishwasher, and also to a conveyor-type dishwasher, in particular to a rack-conveyor dishwasher with the items to be washed being continuously transported.

2. Description of the Background Art

WO 00 53076 discloses a conveyor-type dishwasher, which comprises a wash zone and a final-rinse zone, with items to be cleaned being conveyed through the dishwasher and being sprayed with a cleaning solution inside the wash zone. The cleaned tableware is rinsed clear in the final-rinse zone which follows the wash zone. The dishwasher is driven in such a way that it operates in a cyclical manner, with a conveyor belt being operated at a normal speed and cleaning solution being supplied to the wash zone and, in contrast, fresh water being supplied to the final-rinse zone during an operating cycle. The conveying device in the form of a conveyor belt is stopped and the supply of fresh water to the final-rinse zone is interrupted during a pause cycle.

The dishwasher known from WO 00 53076 comprises a wash zone, a final-rinse zone and a conveyor belt for conveying items to be cleaned through the dishwasher, and also supply devices for supplying cleaning solution to the wash zone, and also nozzles for spraying final-rinse water within the final-rinse zone. A control device for controlling the dishwasher is also provided, with the control device controlling the transportation device in a cyclical manner. The use of a timer of the controller of the wash cycles has the effect that while items being cleaned are conveyed on the conveyor belt in the conveyor direction, cleaning solution is simultaneously supplied to the wash zone 3 and fresh water is simultaneously supplied to the final-rinse zone. During a pause cycle, the conveyor belt with the items being cleaned held on it is still, while the supply of fresh water to the final-rinse zone remains interrupted.

According to this solution, one single conveyor belt, apart from a conveyor belt which is arranged at the inlet and at the outlet, passes through the conveyor-type dishwasher. All zones, be they the wash zone, the cleaning zone or a final-rinse zone, are passed through at the same speed. This solution proposes transporting the items to be cleaned in the conveyor-type dishwasher in a cyclical and non-continuous manner, with rapid transportation entailing short residences times, whereas long residence times can be achieved when the transportation device is at a stop. In other commercially available machines, the items being washed are continuously transported through the machine. In these machines, the zone which has the slowest transportation speed in the method specifies the speed for all zones of the machine.

### SUMMARY OF THE INVENTION

It is therefore an object of the present invention to provide a conveyor-type dishwasher in which the transportation speeds through the individual zones of the conveyor-type dishwasher are matched to the process steps taking place in each of the individual zones in an optimum manner.

In the method proposed according to the invention, transportation devices which are provided in the inlet region and in the outlet region and also transportation devices which may be associated with a preclearing area and also are associated with at least one wash zone, at least one pump-operated final-rinse zone or fresh-water final-rinse zone and also at least one drying zone are driven independently of one another by means of individual drives. The individual drives are actuated by means of a control device. On account of the corresponding predefined values from the controller, it is possible, for example, for the transportation device which is associated with the inlet region and also the transportation device which follows the inlet region and is associated with the first wash zone or the preclearing area to be operated at a slower, first transportation speed level, so that the items to be cleaned run into the conveyor-type dishwasher slowly. In contrast, corresponding actuation of the transportation device which is arranged in a pump-operated final-rinse zone or a fresh-water final-rinse zone at a second, medium transportation speed level means that the items being cleaned, which have passed the preclearing area or the wash zone, can be transported through the pump-operated final-rinse zone or the fresh-water final-rinse zone at a higher speed. Shorter residence times are possible in the zones, be they a pump-operated final-rinse zone or a fresh-water final-rinse zone.

Furthermore, the transportation device which is associated with the drying zone and the transportation device which follows the drying zone in the outlet region are operated by means of the controller of the conveyor-type dishwasher at a third transportation speed level, since the residence times in the drying zone, in which the cleaned and rinsed tableware is dried, can turn out to be even shorter.

In the method proposed according to the invention, it is possible, given corresponding design of the controller, to operate all of the transportation devices using individual drives in the form of electric motors which are respectively associated with the transportation devices. In addition, it is also possible to combine individual transportation devices to form groups of transportation devices. It is therefore possible, for example, to combine the transportation device of the inlet region and the, as seen in the conveyor direction of the items being cleaned, following transportation device of the preclearing area or, if there is no preclearing area, of the first wash zone to form a group. Furthermore—as already hinted at above—the transportation device which is associated with the drying zone can be combined with the transportation device which is associated with the outlet region to form a group.

The controller which is associated with the conveyor-type dishwasher is designed such that it subjects the individual drives of the individual transportation devices or the groups of transportation devices to at least two transportation speed levels.

The transportation speed levels which can be realized on the individual drives for the transportation devices by means of the controller of the conveyor-type dishwasher preferably include a first, slow transportation speed level, in order, for example, to extend the residence time of the cleaning solution in the preclearing zone or in the at least one wash zone. A second, medium transportation speed level can also be realized, which, for example, is associated with the individual drive that drives the transportation device that is associated with the pump-operated final-rinse zone or the fresh-water final-rinse zone. In the transportation device, a shorter residence time of the pump-operated final rinse water or the fresh water on the cleaned items is possible; a fact which can be taken into account by virtue of the second transportation speed level for the individual drives. In addition, the controller of the conveyor-type dishwasher allows an individual drive to be actuated at a third transportation speed level in which the highest speed at which the items being cleaned are conveyed through the conveyor-type dishwasher can be achieved. The third, highest transportation speed level can be realized, for example, within the drying zone on the transportation device provided in the drying zone.

The abovementioned transportation devices may be in the form of plastic conveyor belts, chains, belts or push rods with carry-along catches. The invention also relates to a conveyor-type dishwasher on which at least one wash zone and at least one final rinse zone are realized. Furthermore, a preclearing zone, an inlet region, a drying zone and also an outlet region which is connected downstream of a drying zone can be provided on the conveyor-type dishwasher. The final-rinse zone may be provided both as a pump-operated final-rinse zone and also as a fresh-water final-rinse zone. The proposed conveyor-type dishwasher has transportation devices which can be actuated independently of one another and which can each have a separate associated individual drive in one design variant. In addition, it is also possible for individual transportation devices of successive zones, for example the inlet region and the preclearing area or the inlet region and the first wash zone, to be combined with one another to form a group, so that one individual drive may optionally be saved. This similarly applies to the outlet region of a conveyor-type dishwasher, it advantageously being possible for the transportation device of the outlet region to be coupled to the transportation device which is associated with the drying zone of the conveyor-type dishwasher.

In addition to combination to form groups of individual drives, it is also possible to mechanically couple individual transportation devices to one another. Couplings in the form of belt mechanisms and chain mechanisms, for example, can be used for this purpose. When belt mechanisms or chain mechanisms are used, it is also possible to set different conveying speeds within a group of transportation devices by stepping up or stepping down the transportation speed level. It is also possible to use crank mechanisms in place of belt mechanisms or chain mechanisms, it being possible for belt rollers which are situated opposite one another in the conveyor direction and are associated with the transportation devices to be connected by means of the crank mechanisms. Depending on the number of coupling points, two or more belt-like transportation devices can be combined, with the result that individual drives can be dispensed with.

The solution proposed according to the invention allows a conveyor-type dishwasher to be operated such that resources are saved. The adapted transportation speed of the items being cleaned means that, depending on the process step taking place in the respective zone of the conveyor-type dishwasher, both energy, in terms of the temperature of the water and the heating power to be applied, and also chemical agents, which are to be employed and added to the cleaner solution, can be metered in an optimum manner, and water consumption can be reduced to a minimum while still providing a satisfactory washing result. On account of the method proposed according to the invention for operating a conveyor-type dishwasher and on account of the design of the conveyor-type dishwasher proposed according to the invention, residence times which are each optimally adapted in terms of the method can be achieved for the individual phases of cleaning with regard to the preclearing area, cleaning in at least one wash zone, rinsing the cleaned items clear within a pump-operated final-rinse zone or a fresh-water final-rinse zone and also with regard to drying the items which have been cleaned in the drying zone. Furthermore, the solution proposed according to the invention ensures that a uniform transportation speed which is matched to the method and does not involve stopping and starting is achieved and that the items being cleaned are acted on in a uniform and optimum manner.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conveyor-type dishwasher having transportation devices which are respectively associated with the zones and which can be driven by means of individual drives which are independent of one another,

FIG. 2 shows a conveyor-type dishwasher having individual drives which are associated with each individual zone and can be separately actuated by means of a controller; and

FIG. 3 shows a design variant of a conveyor-type dishwasher proposed according to the invention in which adjacent transportation devices are mechanically coupled to one another.

### DETAILED DESCRIPTION

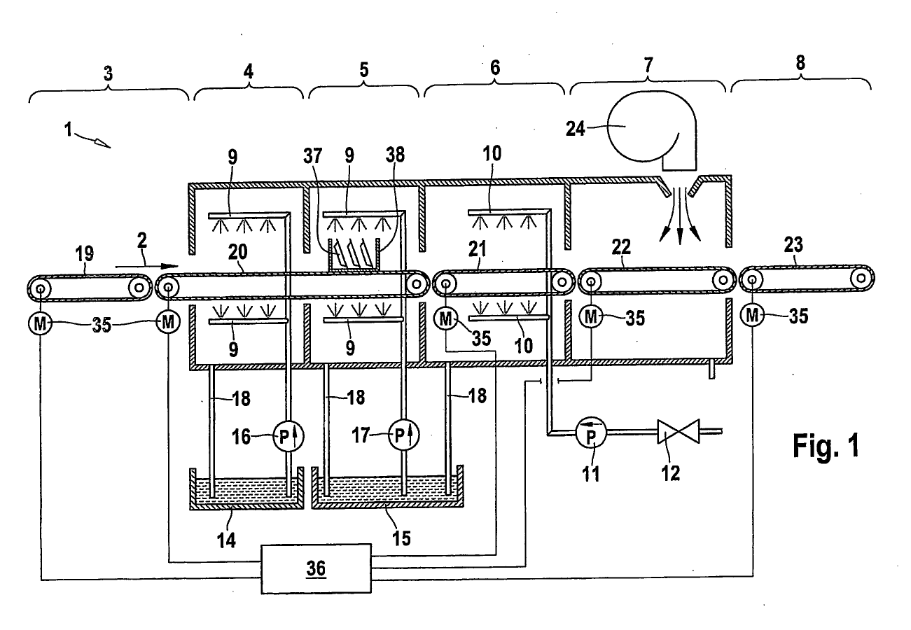

The illustration according to FIG. 1 shows a first design variant of a conveyor-type dishwasher proposed according to the invention which comprises transportation devices which can be driven independently of one another.

A conveyor-type dishwasher 1 transports items that are to be cleaned in a conveyor direction 2. An inlet region 3 is provided which comprises a first transportation device 19 which, for example, may be in the form of a revolving belt. The first transportation device 19 has an associated individual drive 35 which, for its part, is connected to a controller 36 which is associated with the conveyor-type dishwasher 1. The inlet region 3 is followed by a preclearing zone 4 in which the items 37 to be cleaned can be roughly cleaned. The preclearing zone 4 is not absolutely necessary but represents an element which can optionally be provided on a conveyor-type dishwasher 1. In the illustration according to FIG. 1, a second transportation device 20 which may also be in the form of a belt is associated with the preclearing zone 4. The second transportation device 20 is likewise driven by means of an individual drive 35 which is connected to the controller 36 of the conveyor-type dishwasher 1 and is actuated by means of the controller. A washing system 9 is located within the preclearing zone 4. The washing system 9 is charged by means of a first circulation pump 16 which conveys washing liquor or cleaner solution from a first tank 14. Washing liquor or cleaner solution which drips off the items being cleaned 37 falls back into the first tank 14 through a drip tube 18 and is collected by the tank.

The preclearing zone 4 is followed by a wash zone 5. In the illustration according to FIG. 1, the second transportation device 20 extends both through the preclearing zone 4 and through the wash zone 5. The wash zone 5 comprises a further washing system 9 which is charged by means of a second circulation pump 17 which conveys cleaner solution from a second tank 15. The washing liquor which drips off the items 37 being cleaned is conducted through the drip tube 18 into the second tank 15 underneath the conveyor-type dishwasher 1.

The wash zone 5 is followed by a final-rinse zone 6. The final-rinse zone 6 contains a final-rinse system 10. A third transportation device 21, which is likewise driven by means of an independent individual drive 35, which, for its part, is connected to the controller 36 of the conveyor-type dishwasher 1 and is actuated by the controller, is associated with the final-rinse zone 6. The final-rinse system 10 of the final-rinse zone 6 can - as indicated in FIG. 1—optionally be supplied with fresh water via a pump 11. A valve 12 is connected upstream of the pump 11. The fresh water supplied for the final-rinse system via the valve 12 of the pump 11 can be brought to a relatively high temperature in a continuous-flow water heater or boiler (not shown).

Instead of a freshwater final-rinse system, as is illustrated in FIG. 1 in conjunction with the final-rinse zone 6, the final-rinse zone 6 may also be designed as a pump-operated final-rinse zone in which the items 37 which have been cleaned can be rinsed off with cleaning solution which has been highly diluted with fresh water, before the items reach the drying zone 7.

The abovementioned drying zone 7 follows the final-rinse zone 6 which may be in the form of a freshwater final-rinse system or a pump-operated final-rinse system. A fourth transportation device 22 which is likewise driven by means of an individual drive 35 which is connected to the controller 36 is associated with the drying zone 7. Furthermore, a drying blower 24 is associated with the drying zone 7.

An outlet region 8 which comprises a further, fifth transportation device 23 follows the drying zone 7 of the conveyor-type dishwasher 1. The fifth transportation device 23 likewise has an associated individual drive 35 which may, for example, be designed as an electric motor and is connected to the controller 36 of the conveyor-type dishwasher 1 and actuated by the latter.

The method proposed according to the invention and the conveyor-type dishwasher which is formed in a corresponding manner make it possible to always reach an optimum transportation speed when continuously transporting the items 37 to be cleaned through the conveyor-type dishwasher 1 into the individual zones 4, 5, 6 and 7 of the conveyor-type dishwasher as a function of the process steps being executed there. The controller 36 of the conveyor-type dishwasher 1, which can be seen in FIG. 1, can be used to preset the individual drives 35, which in this design variant are associated with one of each of the transportation devices 19, 20, 21, 22 and 23, individually and independently of one another. The controller 36 of the conveyor-type dishwasher 1 implements actuation of the individual drives 35 for at least two different transportation speed levels.

In addition to the transportation devices 20, 21 and 22 which are respectively associated with the preclearing zone 4 and the wash zone 5, the final-rinse zone 6 and the drying zone 7, it is also possible to use the controller 36 of the conveyor-type dishwasher 1 to actuate the first transportation device 19 of the inlet region 3 and the fifth transportation device 23 of the outlet region 8 individually and independently of one another.

Therefore, the first transportation device 19 of the inlet region 3 and the second transportation device 20 which is associated with the preclearing zone 4 and the wash zone 5 in the variant according to FIG. 1 can, for example, be driven at a first transportation speed level given corresponding actuation of the individual drives 35 by means of the controller 36, as a result of which the items 37 being cleaned can be passed through the conveyor-type dishwasher 1 at slow advancing speeds. This is particularly of interest for the preclearing zone 4 in which the items 37 being cleaned are roughly cleaned by the washing system 9, and also for the wash zone 5 in which the items 37 are cleaned, and this is why relatively long residence times are desirable here. Relatively long residence times can be achieved by a drive of the second transportation device 20, which extends through the preclearing zone 4 and the wash zone 5, when the individual drive 35 of the second transportation device is actuated at a first, slow transportation speed level.

In contrast, it is desirable in terms of freshwater consumption and the process temperature in the final-rinse zone 6 - be it a pump-operated final rinse zone or a fresh-water final-rinse zone—to achieve somewhat shorter residence times in order to wash away washing liquor or particles of dirt which are still attached to the items being cleaned. For this reason, the third transportation device 21, which is associated with the final-rinse zone 6, can be operated by means of the individual drive 35 at a second, medium transportation speed level given appropriate actuation by means of the controller 36. The quantity of fresh water emerging from the final-rinse system 10 can therefore be reduced in an optimum manner and lowered to the actual minimum requisite level of consumption.

The residence time which is the shortest compared to other processes being executed in the conveyor-type dishwasher 1 is required in the drying zone 7 with which the fourth transportation device 22 is associated. A third, relatively high transportation speed level can be reached on the individual drive 35 in the drying zone 7 by means of corresponding actuation of the individual drive 35 by means of the controller 36 of the conveyor-type dishwasher 1. The items 37 which have been cleaned and rinsed clear can therefore be effectively dried in the drying zone 7 since the relatively short, achievable residence times of the warm air emerging via the drying blower 24 suffice to evaporate droplets of water which adhere to the items which have been cleaned and prevent excessive heating of the items 37 which have been cleaned and emerge from the drying zone 7 and arrive at the outlet region 8.

It is advantageously possible, as a result of the concept proposed according to the invention, to actuate the first transportation device 19 and the second transportation device 20 by means of their individual drives 35 at an identical, first transportation speed level. This is also possible, for example, in the outlet region 8 of the conveyor-type dishwasher 1, in which both the fourth transportation device 22 which is associated with the drying zone 7 and the fifth transportation device 23 which is associated with the outlet region 8 can be operated at an identical, in this case relatively high, third transportation speed level.

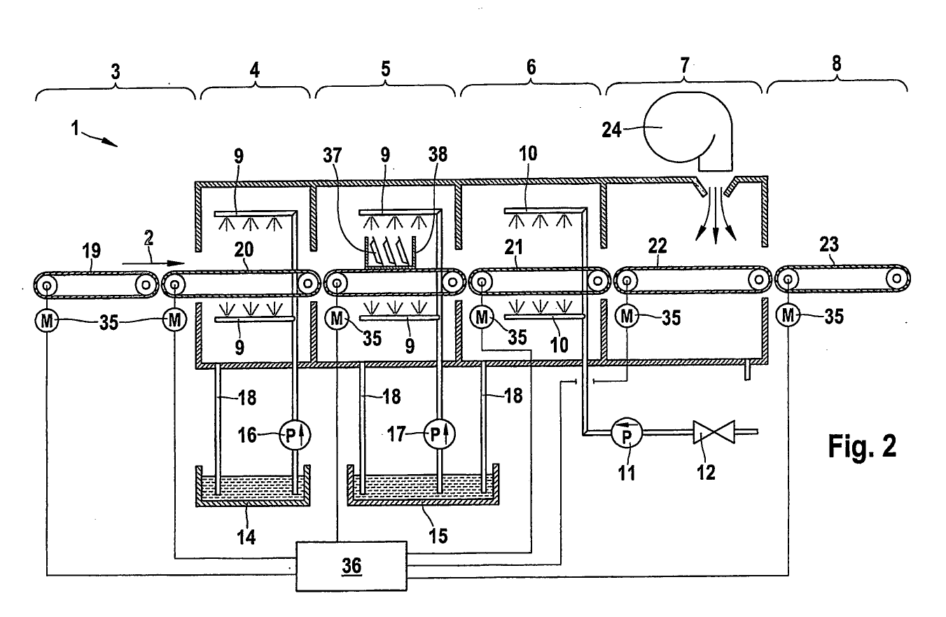

FIG. 2 shows a further design variant of a conveyor-type dishwasher which is suitable for carrying out the method proposed according to the invention.

In contrast to the design variant of a conveyor-type dishwasher 1 proposed according to the invention and illustrated in FIG. 1, a separate transportation device 20 and, respectively, 25 is provided both in the preclearing zone 4 and in the wash zone 5 in the conveyor-type dishwasher 1 illustrated in FIG. 2. Therefore, the transportation speeds of the items 37 being cleaned, which pass through the preclearing zone 4 and the wash zone 5, are not coupled to one another. It is therefore possible for the controller 36 to set different transportation speeds for the items 37 being cleaned in the preclearing zone 4 and the wash zone 5 by correspondingly actuating the individual drives 35. For example, a relatively long residence time may be required in the preclearing zone 4, so that the controller 36 can apply a first transportation speed level to the individual drive 35 which is associated with the second transportation device 20. In contrast, the individual drive 35 for the sixth transportation device 25 in the wash zone 4 may be operated at a second, medium transportation speed level in the design variant according to FIG. 2 since coarse foreign matter was already removed from the items 37 being cleaned in the preclearing zone 4, for which reason a shorter residence time for the washing liquor or cleaner solution may be desirable in the wash zone 5, not least with a view to saving energy and environmental resources, for example water consumption etc.

Apart from the above-described difference, that is to say equipping the wash zone 5 with its own separate sixth transportation device 25, the design variant of the conveyor-type dishwasher 1 shown in FIG. 2 is identical to the design variant illustrated in FIG. 1.

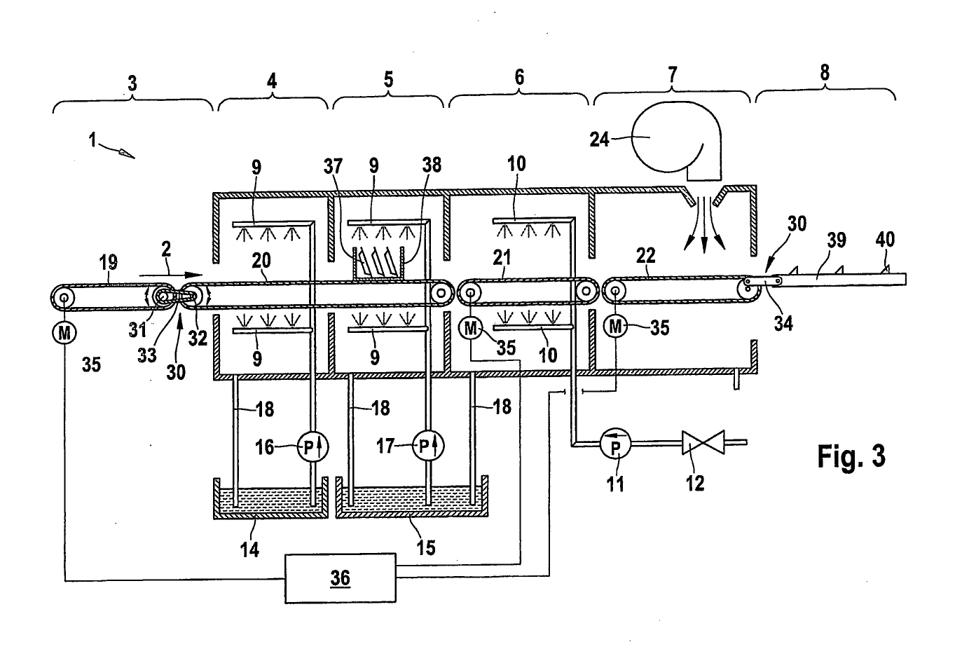

The illustration according to FIG. 3 shows a further possible design of a conveyor-type dishwasher designed according to the invention, in which individual transportation devices are coupled to one another.

The illustration according to FIG. 3 shows a conveyor-type dishwasher 1 through which items 37 to be cleaned are conveyed in the conveyor direction 2. The conveyor-type dishwasher 1 comprises the preclearing zone 4, the wash zone 5, the final-rinse zone 6 and the drying zone 7. The inlet region 3 is connected upstream of the preclearing zone 4, while the outlet region 8 is arranged downstream of the drying zone 7. The inlet region 3 comprises the first transportation device 19 which, for its part, has an independently individually controllable drive 35 which can be actuated by means of the controller 36. The second transportation device 20 passes through the preclearing zone 4 and the wash zone 5. The final-rinse zone 6 comprises the third transportation device 21, while the fourth transportation device 22 is accommodated in the drying zone. The fifth transportation device 23 which may be in the form of a belt is connected downstream of the fourth transportation device 22. The fourth transportation device 22 and the fifth transportation device 23 each have an individual drive 35 which may be in the form of an electric motor. The two individual drives 35 for the fourth transportation device 22 and the fifth transportation device 23 are controlled by means of the controller 36 of the conveyor-type dishwasher 1.

The illustration according to FIG. 3 shows that the first transportation device 19 and the second transportation device 20 for the preclearing zone 4 and the wash zone 5 are coupled to one another by a coupling 30. The coupling 30 may be carried out, for example, by a traction gear mechanism 33 in the form of a belt mechanism or a chain mechanism. To this end, the deflection rollers on which the transportation devices 19 and 20, which are preferably in the form of a belt, revolve each have associated belt disks or chain wheels 31, 32 around which a revolving traction means 33 in the form of a belt or a chain revolves. Depending on the diameter selected for the belt disks or chain wheels 31, 32, the transportation speed which is set by means of actuating the individual drive 35 on the first transportation device 19 can be stepped up or stepped down between the first transportation device 19 which has an associated individual drive 35 and the second transportation device 20 for the preclearing zone 4 and the wash zone 5.

By way of example, a coupling 30 is also provided between the fourth transportation device 22 of the drying zone 7 and the fifth transportation device 39 of the outlet region 8 in the design variant of a conveyor-type dishwasher according to the illustration in FIG. 3. The coupling 30 between the fourth transportation device 22 and the fifth transportation device 39 is realized in the form of a crank mechanism 34. In this case, the fifth transportation device is designed as a push rod 39 in which carry-along catches 40 transport transportation racks 38 containing the items 37 being cleaned. Depending on the articulation points and lever lengths provided on the crank mechanism 34, the on the fourth transportation device 22 can also be stepped up or stepped down in the outlet region 8 of the conveyor-type dishwasher 1 with respect to the push rod 39 with carry-along catches 40 which is coupled to the fourth transportation device 22 by means of the coupling 30 in the form of a crank mechanism 34. In the illustration according to FIG. 3, the individual drive 35 which is associated with a push rod 39 is dispensed with. In the design variant according to FIG. 3, the conveyor-type dishwasher 1 has only three individual drives 35 for the first transportation device 19, the third transportation device 21 in the drying zone 7, and the fourth transportation device 22. The individual drives 35 are all actuated by means of the controller 36, whereas the transportation speed level on the second transportation device 20 and the transportation speed level on the fifth transportation device 23 and, respectively, on a push rod 39 with carry-along catches 40 is set in accordance with the step-up and step-down ratios of the coupling 30. Friction wheel drives or the like could also be used in place of the illustrated traction mechanism 33 or the crank mechanism 34.

Sensors and rocker switches or rocker levers can be operated directly by the items 37 being cleaned or the rack 38 holding the items 37 being cleaned and trigger corresponding functions, for example switching on the drying blower 24 or switching on the fresh-water supply for the final-rinse system 10 or a switch-on operation for the circulation pumps 16 and 17 for the washing systems 9 in the preclearing zone 4 or in the wash zone 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for transporting items to be cleaned through a conveyor-type dishwasher having at least one wash zone and a final-rinse zone, with the items to be cleaned being cleaned in the wash zone and rinsed clear in the final-rinse zone, the method comprising:
providing transportation devices for transporting the items being cleaned in a conveyor direction at a transportation speed which is optimum for the process steps being executed in respective zones;
driving each of the transportation devices or groups of transportation devices via individual drives; and
actuating at least the individual drives that are associated with the wash zone, the final-rinse zone, and a drying zone being actuated by a controller, which specifies at least two transportation speed levels for the individual drives.

2. The method as claimed in claim 1, wherein the individual drives that are associated with an inlet region, a preclearing zone, and an outlet region are additionally actuated by the controller that is used to specify the at least two transportation speed levels for the individual drives.

3. The method as claimed in claim 1, wherein a first transportation device, which is associated with an inlet region, is coupled to a second transportation device of a subsequent preclearing zone or a subsequent wash zone.

4. The method as claimed in claim 1, wherein a fifth transportation device, which is associated with an outlet region, is coupled to a fourth transportation device, which is associated with the drying zone.

5. The method as claimed in claim 1, wherein the individual drives are set by the controller to a first, slow transportation speed level, or to a second, medium transportation speed level, or to a third, high speed level.

6. The method as claimed in claim 1, wherein the transportation are operated at increasing transportation speeds in the conveyor direction of the items being cleaned.

7. The method as claimed in claim 6, wherein the transportation devices, which are associated with the preclearing zone and the wash zone are operated at a first, relatively slow transportation speed level.

8. The method as claimed in claim 6, wherein the transportation device, which is associated with the final-rinse zone, is operated at a second, medium transportation speed level.

9. The method as claimed in claim 6, wherein the transportation device, which is associated with the drying zone, is operated at a third, relatively high transportation speed level.

10. A conveyor-type dishwasher comprising:
an inlet region;
at least one wash zone;
at least one final-rinse zone;
a drying zone;
an outlet region;
a plurality of transportation devices being provided in a conveyor direction of the items being cleaned each of the transportation devices have an individual drive associated therewith; and
a controller operating each of the individual drives at transportation speeds that are matched to processes being executed in process zones to achieve optimum residence times, the controller actuating the individual drives individually and independently of one another.

11. The conveyor-type dishwasher as claimed in claim 10, wherein a first transportation device with an individual drive is associated with the inlet region, a second transportation device with an individual drive is associated with the preclearing zone and the wash zone, a third transportation device with an individual drive is associated with the final-rinse zone, a fourth transportation device with an individual drive is associated with the drying zone, and a fifth transportation device with an individual drive is associated with the outlet region.

12. The conveyor-type dishwasher as claimed in claim 11, wherein the individual drive of the first transportation device and the individual drive of the second transportation device of the preclearing zone and the wash zone are driven by the controller at a first, slow transportation speed level, in order to increase the residence time.

13. The conveyor-type dishwasher as claimed in claim 11, wherein the third transportation device of the final-rinse zone is driven via the individual drive by the controller at a second, medium transportation speed level.

14. The conveyor-type dishwasher as claimed in claim 11, wherein the fourth transportation device of the drying zone is operated by the individual drive and the controller at a third, higher transportation speed level.

15. The conveyor-type dishwasher as claimed in claim 10, wherein the individual drives of the transportation devices can be combined to form functional groups with reference to the transportation speeds to be set for the items being cleaned.

16. The conveyor-type dishwasher as claimed in claim 10, wherein the transportation devices of the conveyor-type dishwasher are mechanically connected to one another by couplings.

17. The conveyor-type dishwasher as claimed in claim 10, wherein the coupling is a traction mechanism with a revolving traction means via which the transportation devices are connected to one another, and the transportation speeds are stepped down or stepped up between the transportation devices that are coupled to one another by the traction mechanism.

18. The conveyor-type dishwasher as claimed in claim 10, wherein the coupling of transportation devices, which are positioned one behind the other in the conveyor direction of the items being cleaned, is a crank mechanism.
